(19) United States
(12) Patent Application Publication
(10) Pub. No.: US 2016/0312848 A1
(43) Pub. Date: Oct. 27, 2016

(54) MOVABLE ELEMENT, DAMPING SYSTEM AND METHOD FOR IMPLEMENTING A MOVABLE ELEMENT

(71) Applicant: SECO-E.P.B., Bouxwiller (FR)

(72) Inventors: Alain FREYERMUTH, Pfaffenhoffen (FR); Mathieu OSTERMANN, Allenwiller (FR); Yannick GROLL, Reitwiller (FR); Pascal KRUMHORN, Dauendorf (FR)

(21) Appl. No.: 15/101,471

(22) PCT Filed: Nov. 28, 2014
(86) PCT No.: PCT/EP2014/076006

§ 371 Date: Jun. 3, 2016

(30) Foreign Application Priority Data
Dec. 5, 2013 (FR) 1362154

(51) Int. Cl. F16F 7/108; F16F 7/10; B23Q 11/00

(52) U.S. Cl. CPC F16F 7/108; B23Q 11/0035; F16F 7/1028

(57) ABSTRACT

A movable element for a damping system includes an absorbent mass arranged to be positioned in a housing. At least two damping assemblies are positioned respectively against the surface of the absorbent mass and bearing against the internal wall of the housing at different parts of the absorbent mass. The movable element is arranged to function with a phase shift and/or shift of displacement amplitude between the oscillations of each part of the absorbent mass in each of the damping assemblies during the operation of the movable element, by generating damping effects and/or having different rigidity for each of the damping assemblies. The present disclosure further relates to damping system and method for implementing a movable element.

### BACKGROUND AND SUMMARY

The present invention relates to the field of damping devices for apparatus and tools and more particularly to the field of adaptable damping devices for cutting and drilling apparatus and tools.

The mounting of tools onto an adapted interface of a motor-driven device often requires the insertion of an intermediate part designed to limit the vibrations of the moving apparatus and tool. In the case of a tool that rotates, for example a cutting or drilling tool, vibrations can be caused by the resistance encountered by the cutting tool when in contact with the material of the cut piece. Said radial vibrations then interfere with the rotational movement of the cut part in relation to its axis of rotation. The intermediate damping device makes it possible to compensate for, even cancel out, the radial vibrations which may be produced by the tool in rotation.

Generally, said intermediate damping device is formed by a cylindrical part which forms a housing in which a centred cylindrical absorbent mass is located in the housing and held in position by elastic elements arranged on the periphery of the cylindrical mass in contact with the internal wall of the cylindrical housing. The function of this absorbent mass is to vibrate in a different phase to the cylindrical part of the housing and thus dampen the radial vibrations generated by cutting and in particular by the resistance encountered by the cutting tool. The damping device/cylindrical mass assembly is then arranged in alignment with the axis of rotation of the machine and the tool. The different elastic elements enable damping of the vibrational movements of the absorbent mass relative to the cylindrical part of the housing. Said damping can be controlled by modifying the elastic rigidity of the elastic suspension and/or the mass of the absorbent mass.

However, in existing devices to ensure that said absorbent mass is able to perform effective damping, it is necessary for the mass to vibrate in displacement at a frequency close to or identical to that of the tool to be damped while maintaining a phase shift relative to the vibrations of the tool to be damped. However, depending on the operation, the type of clamping, the type of spindle, the axis of orientation, vertical or horizontal, of the tool holder, the rigidity of the machine, the operating tool can have a vibration frequency that is likely to vary. This variation in the vibrations during the operation of the tool can therefore be the cause of a problem with the effectiveness of the damping of said vibrations by the absorbent mass.

The aim of the present invention is in particular to overcome these disadvantages by proposing a damping device which is adapted to perform an effective damping of the vibrations of a tool over an extended vibrational range at the same time enabling a possible control of the suspension.

In accordance with an aspect of the present invention, a movable element for a damping system comprises an absorbent mass designed to be positioned in a housing and comprising at least two damping assemblies which are positioned respectively against the surface of the absorbent mass and designed to bear against the internal wall of the housing in different parts of the absorbent mass, wherein the movable element is arranged to function with a phase shift and/or shift of displacement amplitude between the oscillations of each part of the absorbent mass in each of the damping assemblies during the operation of the movable element, by generating damping effects and/or having different rigidity for each of the damping assemblies.

In accordance with another aspect of the present invention, a damping system comprises at least one movable element according to the invention.

In accordance with another aspect of the present invention, a method for implementing a movable element according to the invention in a damping system for a vibration damping operation, comprises at least one step of generating a phase shift and/or shift of displacement amplitude between each of the parts of the absorbent mass during the oscillating displacement of the absorbent mass relative to the housing.

### BRIEF DESCRIPTION OF THE DRAWINGS

The features and advantages of the present invention are well understood by reading the following detailed description in conjunction with the drawings in which like numerals indicate similar elements and in which:

FIG. 1 is a comparative representation of the displacement of different parts of the absorbent mass in relation to the housing of a damping system,

FIG. 2 is a schematic cross-sectional representation of a first embodiment of a movable element according to the invention integrated into a damping system,

FIG. 3 is a schematic cross-sectional representation of a second embodiment of a movable element according to the invention integrated into a damping system,

FIG. 4 is a schematic cross-sectional representation of a third embodiment of a movable element according to the invention integrated into a damping system,

FIG. 5 is a schematic cross-sectional representation of a fourth embodiment of a movable element according to the invention integrated into a damping system,

FIG. 6 is a schematic cross-sectional representation of a fifth embodiment of a movable element according to the invention integrated into a damping system,

FIG. 7 is a schematic cross-sectional representation of a sixth embodiment of a movable element according to the invention integrated into a damping system.

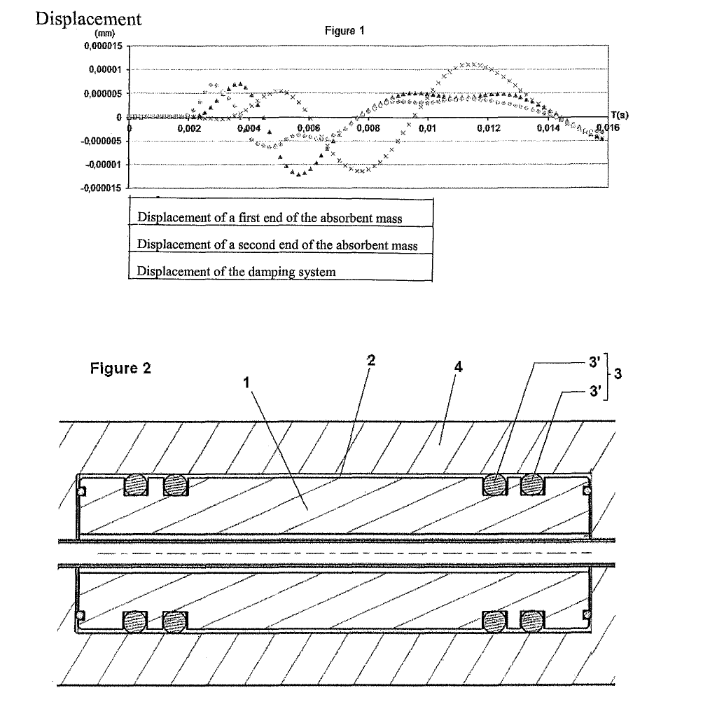

### DETAILED DESCRIPTION

The invention relates to a movable element for a damping system 4 comprising an absorbent mass 1 designed to be positioned in a housing 2 and comprising at least two damping assemblies 3 positioned respectively against the surface of the absorbent mass 1 and designed to bear against the internal wall of the housing 2 of different parts of the absorbent mass 1, wherein the movable element is arranged to operate with a phase shift and/or shift of displacement amplitude between the oscillations of each part of the absorbent mass 1 in each of the damping assemblies 3 during the operation of the movable element, by generating damping effects and/or having different rigidity for each of the damping assemblies 3.

FIG. 1 illustrates that the generation of phase shift effects and/or shifts of displacement amplitude between each of the damping assemblies 3 makes it possible to achieve damping over a greater range of vibration frequencies. In fact, in the representation of FIG. 1, the signals relating to respective ends of the absorbent mass 1 of a movable element illustrate respective radial displacements of each of the ends of the absorbent mass 1 over time, when the damping system which comprises said absorbent mass in its housing 2 is subjected to a radial shock. The third signal represents the radial displacement over time of the damping system 4 integrating the movable element of the invention, subjected to the same radial shock. It should be noted that this third signal shows a reduction of its amplitude relative to the radial oscillations of the two other signals, showing greater damping of the vibrations because of the damping effects and/or different hardnesses of each of the damping assemblies 3 of the device.

Said phase shift effect and/or shift of displacement amplitude can be achieved, on the one hand by influencing the specific damping properties and/or rigidity of each of the damping assemblies 3, and on the other hand by modifying the characteristics of the absorbent mass 1 of the movable element. It should be noted that these methods of technical intervention for modifying a phase shift effect and/or shift of displacement amplitude are not incompatible.

The movable element may have damping assemblies 3 positioned in each part of the absorbent mass 1 and they have different damping properties and/or rigidity.

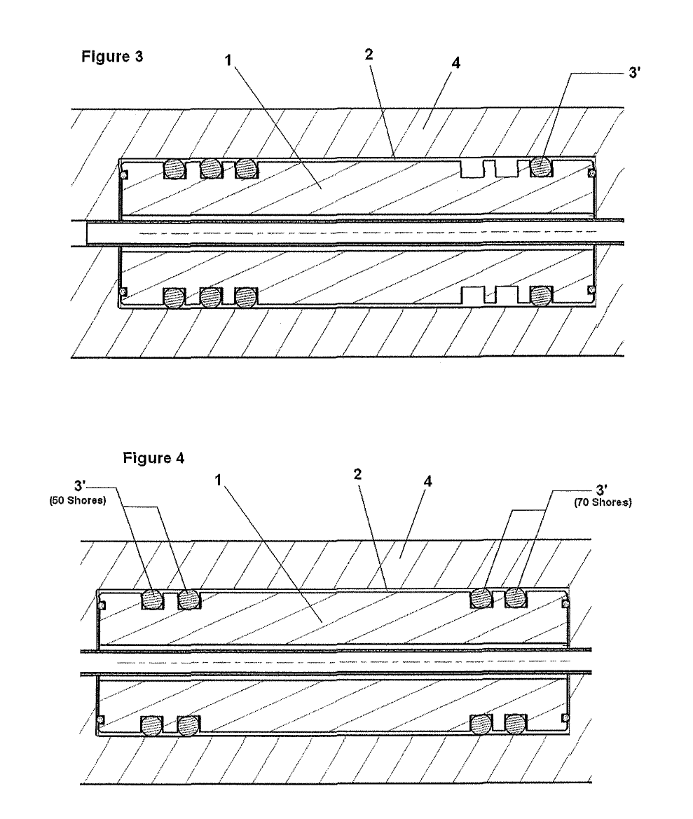

It is possible to achieve different damping properties and/or rigidity by means of damping assemblies 3 formed respectively by a different number of one or more elastic elements 3′, said elements being designed to be held clamped in position between the absorbent mass 1 and the internal wall of the housing 2. This difference in the number of elastic elements 3′, as illustrated by way of the example in FIG. 3, makes it possible to obtain an imbalance between the respective damping abilities and/or rigidity of the damping assemblies 3.

According to one embodiment, the damping assemblies 3 are formed by elastic elements 3′ positioned in annular grooves arranged at least radially on the periphery of the absorbent mass 1.

According to a first possibility of adjusting the phase shift effect and/or shift of displacement amplitude in connection with this embodiment, the respective number of elastic elements 3′ of each of the damping assemblies 3 is different. Said difference thus generates damping and/or a different rigidity in each of the damping assemblies 3 of the movable element. A non-limiting example of the structure of this embodiment is illustrated in FIG. 3.

According to a second option for adjusting the phase shift effect and/or shift of displacement amplitude in connection with this embodiment, the respective elastic elements 3′ of the damping assemblies 3 have different hardness values. Said difference in hardness between each of the damping assemblies 3 makes it possible to obtain a different deformation of each of the respective elastic elements 3′ of the damping assemblies 3. In case of an identical shock, an elastic element 3′ with greater hardness will be deformed with more difficulty and will ensure damping and a smaller displacement. A non-limiting example of the structure of this embodiment is illustrated in FIG. 4.

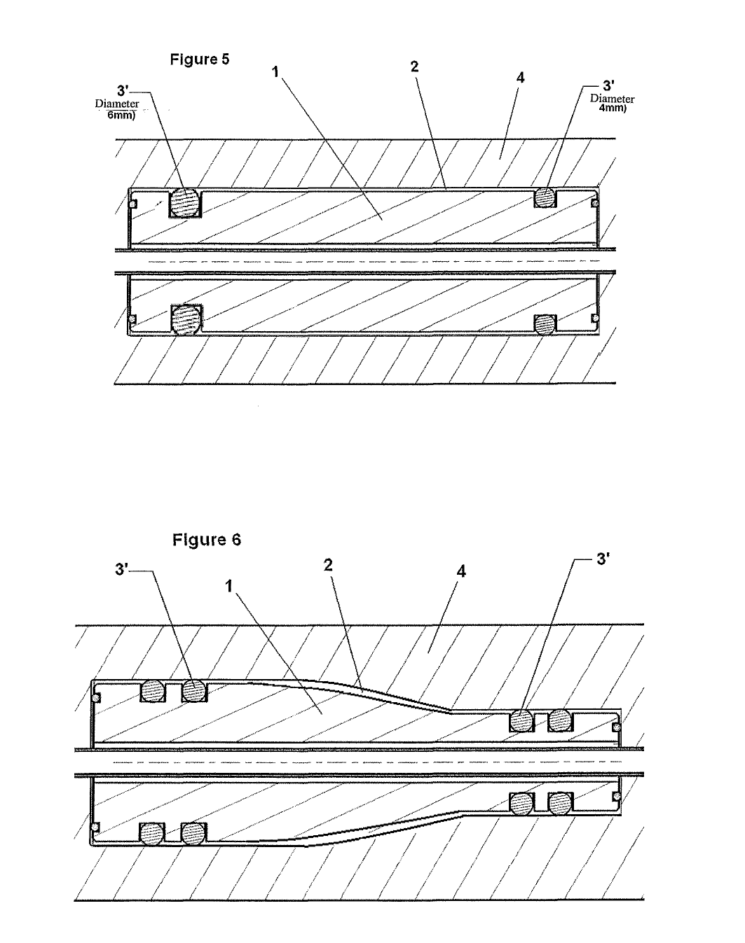

According to a third option for adjusting the phase shift effect and/or shift of displacement amplitude in connection with this same embodiment, the respective elastic elements 3′ of the damping assemblies 3 have sections with different diameters. This difference in cross section also makes it possible to influence the incidence of damping and/or rigidity. In case of an identical shock, an elastic element 3′ with a cross section with a larger diameter ensures greater damping and displacement. A non-limiting example of the structure of said second possible embodiment is illustrated in FIG. 5.

Within the absorbent mass 1 in the movable element there may be a variation in the distribution of mass in the respective damping assemblies 3. It should be noted that this feature is perfectly compatible with the feature of the embodiment described in detail above.

It is possible to achieve a different mass distribution between the damping assemblies 3 in different ways.

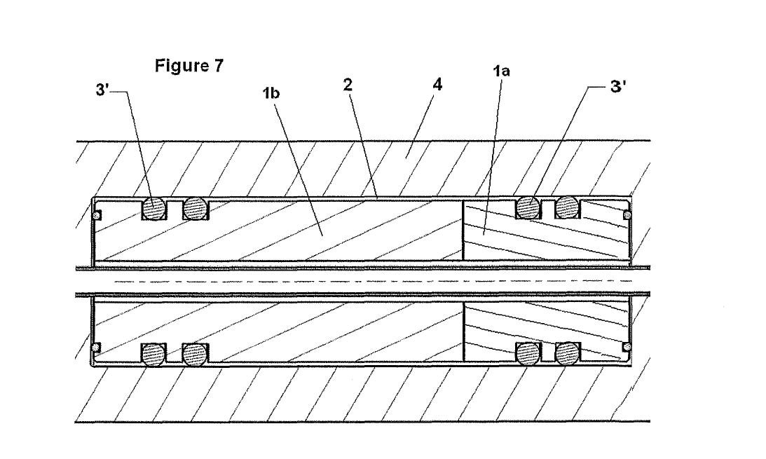

According to a first embodiment, within the absorbent mass 1 there is a variation in the distribution of mass by having a different density in each of the respective parts of the absorbent mass 1 in contact with a damping assembly 3. According to a non-limiting example of the structure of this embodiment as illustrated in FIG. 7, the absorbent mass 1 is formed by at least two elements 1a, 1b with different densities and designed to interact with a respective damping assembly 3.

According to a second embodiment, within the absorbent mass 1 there is a variation in the distribution of mass by having different volumes in each of the respective parts of the absorbent mass 1 in contact with a damping assembly 3. According to a non-limiting example of the structure of this embodiment as illustrated in FIG. 6, the absorbent mass 1 has a variation in cross section in the portion located between the respective parts of the absorbent mass 1 in contact with a damping assembly 3.

It should be noted that the different possible structures mentioned by way of example are embodiments that are compatible with one other in the form of the embodiment of a movable element according to the invention. It should also be noted that although only two damping assemblies 3 have been shown in the different embodiments, it is also possible to have a structure of the movable element involving more than two damping assemblies 3.

The invention also relates to a damping system 4 which comprises at least one movable element according to the invention. Said damping system 4 comprises a housing 2 into which the movable element of the invention is inserted. The damping system can be connected to a cutting or drilling apparatus or a cutting or drilling tool, usually for adapted metal cutting.

The invention also relates to a method for implementing a movable element according to the invention in a damping system 4 in the form of a vibration damping operation. The method comprises at least one step of generating a phase shift and/or shift of displacement amplitude between each of the parts of the absorbent mass 1 during the oscillating displacement of the absorbent mass 1 relative to the housing 2.

Of course, the invention is not limited to the embodiment described and represented in the accompanying drawings. Modifications remain possible, particularly from the point of view of the constitution of the various elements or by substituting equivalent techniques, without departing as such from the scope of protection of the invention.

The disclosures in French patent application No. 1362154, from which this application claims priority, are incorporated herein by reference.

1. A movable element for a damping system comprising:
an absorbant mass disposed in a housing of the damping system, the housing having an internal wall;
at least two damping assembles, each of the damping assemblies being positioned respectively against a surface of the absorbent mass and arranged to bear against the internal wall of the housing at different parts of the absorbent mass, wherein the movable element is arranged to function with a phase shift and/or shift of displacement amplitude between the oscillations of each part of the absorbent mass in each of the damping assemblies during operation of the movable element, by generating damping effects and/or having different rigidity for each of the damping assemblies.

2. The movable element according to claim 1, wherein each of the damping assemblies positioned in each part of the absorbent mass have different damping properties and/or rigidity.

3. The movable element according to claim 1, wherein each of the damping assemblies are formed by a different number of one or more elastic elements held in position between the absorbent mass and internal wall of the housing.

4. The movable element according to claim 3, wherein the elastic elements are positioned in annular grooves arranged at least radially on the periphery of the absorbent mass.

5. The movable element according to claim 3, wherein each of the elastic elements of the damping assemblies have different hardness values.

6. The movable element according to claim 3, wherein each of the elastic elements of the damping assemblies have sections with different diameters.

7. The movable element according to claim 1, wherein the absorbent mass has a different distribution of mass at the respective damping assemblies.

8. The movable element according to claim 7, wherein within the absorbent mass there is a variation in the distribution of mass by having a different density in each of the respective parts of the absorbent mass in contact with a respective damping assembly.

9. The movable element according to claim 7, wherein within the absorbent mass there is a variation in the distribution of mass by having different volumes in each of the respective parts of the absorbent mass in contact with a respective damping assembly.

10. A damping system comprising:
a housing having an internal wall;
at least one movable element disposed in the housing, the at least one movable element including an absorbent mass and a plurality of damping assemblies, each of the damping assemblies being positioned respectively against a surface of the absorbent mass and bearing against the internal wall of the housing at different parts of the absorbent mass, wherein the movable element is arranged to function with a phase shift and/or shift of displacement amplitude between the oscillations of each part of the absorbent mass in each of the damping assemblies during operation of the movable element, by generating damping effects and/or having different rigidity for each of the damping assemblies.

11. The damping system, according to claim 10, wherein the housing is connected to a cutting or drilling apparatus or a cutting or drilling tool.

12. A method for implementing a movable element in a damping system for a vibration damping operation, the method comprising:
providing at least one movable element, the movable element being disposed in a housing of the damping system, the at least one movable element including an absorbent mass and a plurality of damping assemblies, each of the damping assemblies being positioned respectively against a surface of the absorbent mass and bearing against the internal wall of the housing at different parts of the absorbent mass; and
generating a phase shift and/or shift of displacement amplitude between each part of the absorbent mass during an oscillating displacement of the absorbent mass relative to the housing, wherein the movable element is arranged to function with the generated phase shift and/or shift of displacement amplitude between the oscillations of each part of the absorbent mass in each of the damping assemblies during operation of the movable element, by generating damping effects and/or having different rigidity for each of the damping assemblies.
